(19) United States
(12) Patent Application Publication
(10) Pub. No.: US 2009/0167140 A1
(43) Pub. Date: Jul. 2, 2009

(54) Carbon Based Field Emission Cathode and Method of Manufacturing the Same

(76) Inventor: Qiu-Hong Hu, Goteborg (SE)

Correspondence Address: HARNESS, DICKEY & PIERCE, P.L.C., P.O. BOX 8910, RESTON, VA, 20195, US

(21) Appl. No.: 11/988,504

(22) PCT Filed: Jul. 6, 2006
(86) PCT No.: PCT/EP2006/006591

§ 371 Date: Dec. 4, 2008

(30) Foreign Application Priority Data
Jul. 14, 2005 (EP) 05106440.0

(51) Int. Cl. H01J 1/00; H01J 9/04; H01J 9/06

(52) U.S. Cl. 313/311; 445/51; 445/65

(57) ABSTRACT

A method for manufacturing a field emission cathode comprising the steps of providing a liquid compound comprising a liquid phenolic resin and at least one of a metal salt and a metal oxide, arranging a conductive cathode support (2) such that said conductive cathode support comes in a vicinity of said liquid compound (2) and heating said liquid compound (2). By performing the above mentioned steps, a solid compound foam is formed which is transformed from said liquid compound, said solid compound foam at least partly covering said conductive cathode support. Advantage with the novel compound comprises its improved work function and the minimal or non-existing training period. Hence, this novel method will provide the possibility to manufacture a field emission cathode at a fraction of the cost associated with the in prior art used methods and materials.

### TECHNICAL FIELD

The present invention relates to a carbon material for a field emission cathode. The present invention also relates to a method for manufacturing of such a field emission cathode.

### TECHNICAL BACKGROUND

The technology used in modern energy-saving lighting devices uses mercury as one of the active components. As mercury is harmful to the environment, extensive research is done to overcome the complicated technical difficulties associated with energy-saving, mercury-free lighting.

An approach used for solving this problem is by using a field emission device, such as field emission light source. Field emission is a phenomenon which occurs when an electric field proximate to the surface of an emission material narrows a width of a potential barrier existing at the surface of the emission material. This allows a quantum tunneling effect to occur, whereby electrons cross through the potential barrier and are emitted from the material.

In prior art devices, a cathode is arranged in an evacuated chamber, having for example glass walls, wherein the chamber on its inside is coated with an electrically conductive layer, on top of which a light emitting layer is deposited. They together constitute an anode. When a potential difference is applied between the cathode and the anode, electrons are emitted from the cathode and accelerated towards the anode. As the electrons strike the light emitting layer, they cause it to emit photons, a process referred to as cathodoluminescence, which is different from photoluminescence that is employed in conventional fluorescent lighting devices, such as conventional fluorescent tubes.

Cathodes used in field emission devices are accordingly known as field emission cathodes and are considered “cold” cathodes as they do not require the use of a heat source to operate. Among various materials known to be suitable for the construction of field emission cathodes, carbon based materials have proven to be capable of producing significant emission currents over a long lifetime in moderate vacuum environment.

Such a field emission cathode is disclosed in European patent application 99908583, “Field emission cathode fabricated from porous carbon foam material”, wherein the field emission cathode comprises an emission member formed of a porous carbon foam material, such as Reticulated Vitreous Carbon (RVC), where the emissive member has an emissive surface defining a multiplicity of emissive edges. RVC is manufactured using a carbonized polymer resin.

The use of RVC as an emissive member has not been completely successful since the material has a period of instability, which has been termed the material's “training period”, which is believed to result from (i) the desorption of contaminants initially present on the emission surface of the RVC cathode and (ii) by the destruction of the sharpest emissive edges of the RVC material. The latter (ii) leads to a complicated fabrication process involving expensive and complex manufacturing steps. Furthermore, the operation voltage of such a field emission cathode as disclosed above has to be very high in order to obtain a sufficient output current, an effect manifested as too few emission sites over the entire cathode surface.

It is therefore an object of the present invention to address two crucial issues, the total emission current of the cathode at an appropriate voltage interval, and the uniform spatial and current distributions of the emission edges, and thus providing a novel and improved carbon material for a field emission cathode.

### SUMMARY OF THE INVENTION

The above need is met by a carbon material for a field emission cathode and a corresponding method for manufacturing such a field emission cathode as defined in independent claims 1 and 8. The dependent claims define advantageous embodiments in accordance with the present invention.

According to a first aspect of the invention, it is provided a method for manufacturing a field emission cathode comprising the steps of providing a liquid compound comprising a liquid phenolic resin and at least one of a metal, a metal salt, and a metal oxide, arranging a conductive cathode support such that said conductive cathode support comes in a vicinity of said liquid compound, and heating said liquid compound, thereby forming a solid compound foam, transformed from said liquid compound to said solid compound foam at least partly covering said conductive cathode support. Advantages with the novel compound comprises its improved work function and its minimal or non-existing training period. Hence, this novel method will provide the possibility to manufacture a field emission cathode using fewer manufacturing steps and at a fraction of the cost in comparison to the methods and materials used in the prior art.

In the step of heating the liquid compound which preferably takes place in an enclosed container in which the conductive cathode support and the liquid compound have been arranged, the temperature is below 100° C., such as at about 60° C.-90° C. As a result of the heating, the liquid compound will expand in volume, and subsequently form the solid compound foam that comes in firm contact with the conductive cathode support, thereby at least partly covering the conductive cathode support.

The expression work function describes the minimum energy (usually measured in electron volts) needed to remove an electron from the Fermi level to a point at an infinite distance away outside the surface. Furthermore, the expression training period defines the time during which the compound shows sign of instability. The metal salt can in one case be an alkaline metal salt. Similarly, the metal oxide can in one case be Zink oxide. The liquid compound can in a similar manner further comprise one or a plurality of acids compounds, surfactants, dispersion agents and organic or non-organic solvents.

The next steps in manufacturing the field emission cathode comprise the step of performing a pyrolysis process on the solid compound foam at least partly covering said conductive cathode support, thereby forming a carbonized solid compound foam, and then performing a cutting action on said carbonized solid compound foam, thereby forming a plurality of sharp emission edges at the surface of the carbonized solid compound foam. The pyrolysis is preferably performed in a low vacuum environment at about 800° C.-1000° C. For the cutting process there are a large number of techniques available. In a preferred manner, a mechanical cutting process is utilized.

In a preferred embodiment of the present invention, the conductive cathode support is a rod, the container is a substantially cylindrical container, and the step of heating the liquid compound comprises the step of substantially aligning a longitudinal centre axis of the substantially cylindrical container with a horizontal plane axis. Furthermore, the substantially cylindrical container is preferably rotated around its substantially horizontal axis. These inventive manufacturing steps allows for the liquid compound to expand in volume inside the enclosed container in a radial and uniform manner, producing the solid compound foam, in a firm contact with and at least partly covering the conductive cathode support, wherein the solid compound foam has substantially uniform and structured characteristics.

To achieve advantageous coverage of the conductive cathode support, the axis of the conductive cathode support is preferably coincident with the substantially horizontal axis of the substantially cylindrical container.

As understood by the person skilled in the art, the conductive cathode support can be either a rod, as described above, or a substantially flat structure. In the case which involves the substantially flat structure, the container and the substantially flat structure can be one and the same, allowing for the design and construction of a flat field emission cathode that could be utilized in for example large-area stadium-type displays.

The novel carbonized solid compound foam has a continuous cellular structure, having the advantages of two-dimensional interconnected sharp edges, such as knife edges, after cutting. The sharpness of the edges is determined by the thickness of the walls of the cellular structure. According to a second aspect of the present invention it is provided a cathode, for emitting electrons when a potential difference is applied between the cathode and an anode in a field emission device application, comprising a conductive cathode support and a carbonized solid compound foam at least partly covering the conductive cathode support, wherein the carbonized solid compound foam is transformed from a liquid compound comprising a phenolic resin and at least one of a metal salt, a metal oxide. The metal salt and metal oxide can in one case be one of an alkaline metal salt and Zink oxide respectively. The liquid compound can in a likewise manner further comprise one or a plurality of acids compounds, surfactants, dispersion agents and solvents. As described above in relation to the first aspect of the present invention, this novel field emission cathode, with the novel compound, provides a plurality of advantages due to its low work function and the minimal or non-existing training period. Hence, this novel field emission cathode will provide the possibility to produce a field emission cathode at a lower cost with higher performance, as compared with methods and materials used in the prior art.

In a preferred embodiment of the second aspect of the present invention, the carbonized solid compound foam has a continuous cellular structure with a plurality of sharp emission edges arranged at the surface of said carbonized solid compound foam. This allows for an improved emission current. Experimental measurement using a field emission cathode, according to the present invention, in a field emission lamp, has measured an operational current of 3 mA at an operational voltage of 4 kV.

According to a third aspect of the present invention it is provided an apparatus, for manufacturing a cathode, for use in a field emission device application, comprising means for providing a liquid compound comprising a liquid phenolic resin and at least one of a metal salt, a metal oxide, means for arranging a conductive cathode support, such that said conductive cathode support comes in a vicinity of said liquid compound, and means for heating said liquid compound, thereby forming a solid compound foam, transformed from said liquid compound, said solid compound foam at least partly covering said conductive cathode support. This apparatus provides in a similar manner as describe above the possibility to manufacture a field emission cathode at a lower cost compared to materials and methods used in prior art.

According to a fourth aspect of the present invention, it is provided a field emission device application comprising a cathode, said cathode comprising a conductive cathode support and a carbonized solid compound foam at least partly covering said conductive cathode support, wherein said carbonized solid compound foam is transformed from a liquid compound comprising a phenolic resin and at least one of a metal salt, a metal oxide, an anode, means for arranging said anode and said cathode in an evacuated chamber, and control electronics.

In a preferred embodiment of this fourth aspect of the present invention, the field emission device application can be one of a lighting source application and an X-ray source application. Such a field emission device application can be either an enclosed unit or an arrangement comprising, but not limited to, the mentioned components.

Further features and advantages of the present invention will become apparent when studying the appended claims and the following description. Those skilled in the art will appreciate that different features of the present invention can be combined in other ways to create embodiments other than those described in the following.

### BRIEF DESCRIPTION OF THE DRAWINGS

The present invention will now be described in more detail with reference to the accompanying drawings, in which:

FIG. 1a illustrates a schematic side cross-section of a conductive cathode support aligned with a substantially horizontal axis of a substantially cylindrical container.

FIG. 1b illustrates a schematic end cross-section of a conductive cathode support aligned with a substantially horizontal axis of a substantially cylindrical container as illustrated in FIG. 2a.

FIG. 2 illustrates a cross-section of a field emission cathode according to the present invention.

FIG. 3 illustrates the steps of manufacturing a field emission cathode according to the present invention.

FIG. 4a shows a scanning electron microscope microphotography of an incline view of a field emission cathode according to the present invention, showing a carbonized solid compound foam with a plurality of sharp emission edges located at the surface of the carbonized solid compound foam.

FIG. 4b is a close-up view of the scanning electron microscope microphotography view showed in FIG. 4a, illustrating an emission site with the triple junction of the emission edges.

FIG. 4c is a further close-up view of the scanning electron microscope microphotography view showed in FIG. 4a, illustrating sharp emission edges.

FIG. 5 is a graph of the typical emission current/applied voltage (a so called I/V curve) of an experimental test performed on a field emission cathode according to the present invention.

### DETAILED DESCRIPTION OF THE PREFERRED EMBODIMENT

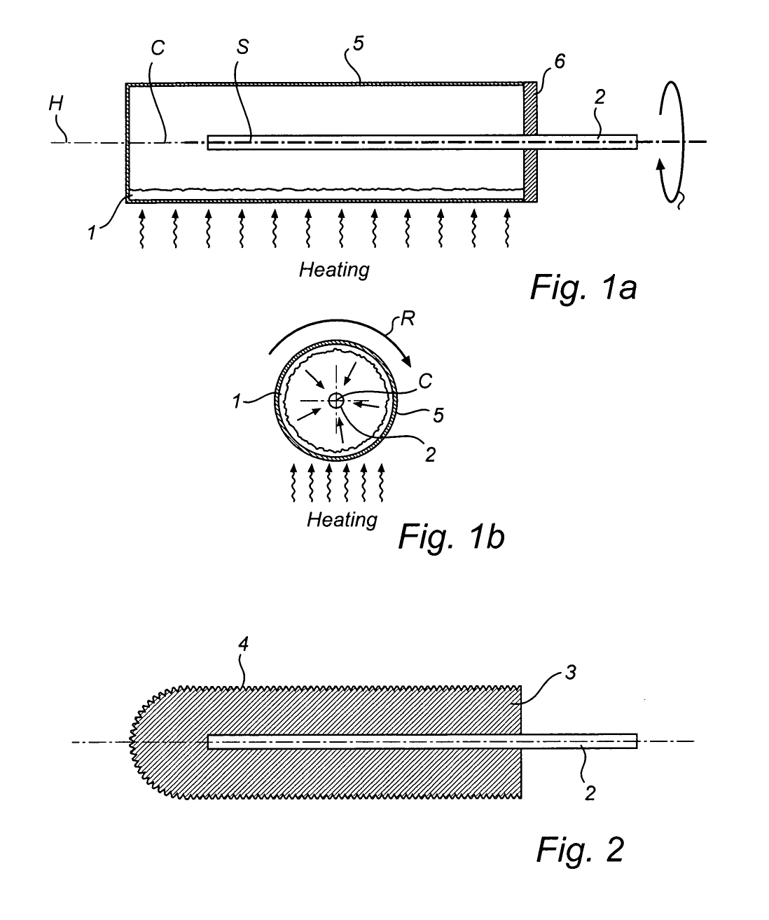

FIG. 1a illustrates a schematic side cross section of an apparatus for some of the initial steps in performing a method according to the present invention. A conductive cathode support 2 has been positioned inside of a substantially cylindrical container 5. The center axis S of the conductive cathode support 2 has been substantially aligned with a center axis C of the substantially cylindrical container 5. Furthermore, the two center axes C and S have been aligned with a horizontal plane H. A lid 6 is enclosing the substantially cylindrical container 5 wherein a liquid compound 1 is heated. The direction of the heating is not limited to only the bottom of the substantially cylindrical container 5, but can of course take place from an arbitrary direction. The substantially cylindrical container 5, is rotatable R around its center axis C.

Moving on to FIG. 1b which illustrates a schematic end cross-section of a conductive cathode support 2, aligned with a substantially horizontal axis C of a substantially cylindrical container 5 as illustrated in FIG. 1a.

FIG. 2 illustrates a cross-section of a field emission cathode according to the present invention. A conductive cathode support 2 is covered by a carbonized solid compound foam 3, having a continuous cellular structure. The field emission cathode further comprises a plurality of sharp emission edges 4 arranged at the surface of the carbonized solid compound foam 3. These emission edges 4 are arranged at uniform emission sites.

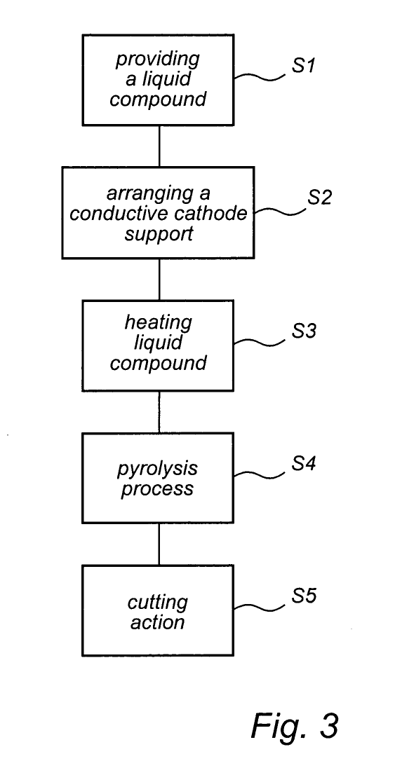

Referring next to FIG. 3, there will be described a method of manufacturing the field emission cathode as described above.

FIG. 3 illustrates the processing steps of manufacturing a field emission cathode according to the present invention. The process steps includes providing S1 a liquid compound 1, arranging S2 a conductive cathode support 2, heating S3 the liquid compound 1, performing a pyrolysis process S4 on the solid compound foam, and performing a cutting action S5 on the carbonized solid compound foam 3. These process steps are carried out in the order of description in the present embodiment.

In the step of providing S1 a liquid compound 1, a compound is prepared. This compound comprises a liquid phenolic resin and at least one of an alkaline metal, an alkaline metal salt, and an alkaline metal oxide, acid compounds, surfactants, dispersion agents and solvents. These ingredients are mixed as thoroughly as possible for them to dissolve properly.

The step of providing S1 the liquid compound 1 is followed by the step of arranging S2 the conductive cathode support 2 such that the conductive cathode support 2 comes in a vicinity of the liquid compound 1. In the case where the conductive cathode support 2 is configured as a rod, this is preferably done by arranging the conductive cathode support 2 inside of the substantially cylindrical container 5 as described in FIGS. 1a and 1b.

The step of arranging S2 the conductive cathode support 2 is followed by the step of heating S3 the liquid compound 1. The heating is done at a temperature below 100° C., such as at about 60° C.-90° C. As a result of the heating, the liquid compound 1 will radial expand in volume, creating the solid compound foam 3 that comes in firm contact with the conductive cathode support 2 as can be seen in FIG. 2. Preferably the conductive cathode support 2 is at least partly covered by the solid compound foam 3. At the same time as the heating takes place, the substantially cylindrical container 5 is rotated R around its center axis C, thereby will the liquid compound expand in volume inside of the enclosed container 5 in a radial and uniform manner, producing the solid compound foam 3 having substantially uniform and structured characteristics. Prior art methods of covering conductive cathode support comprised a “dipping” process that produced a solid compound foam that had non-uniform and non-structured characteristics.

Subsequently, a pyrolysis processing step S4 is performed on the solid compound foam 3 that at least partly covers the conductive cathode support 2. The pyrolysis step S4 is performed in an low vacuum environment at about 800° C.-1000° C.

The pyrolysis step S4 is followed by a mechanical cutting step S5. The field emission cathode is arranged in a mechanical cutting machine, wherein the carbonized solid compound foam gets a plurality of sharp emission edges 4 at the surface of the carbonized solid compound foam.

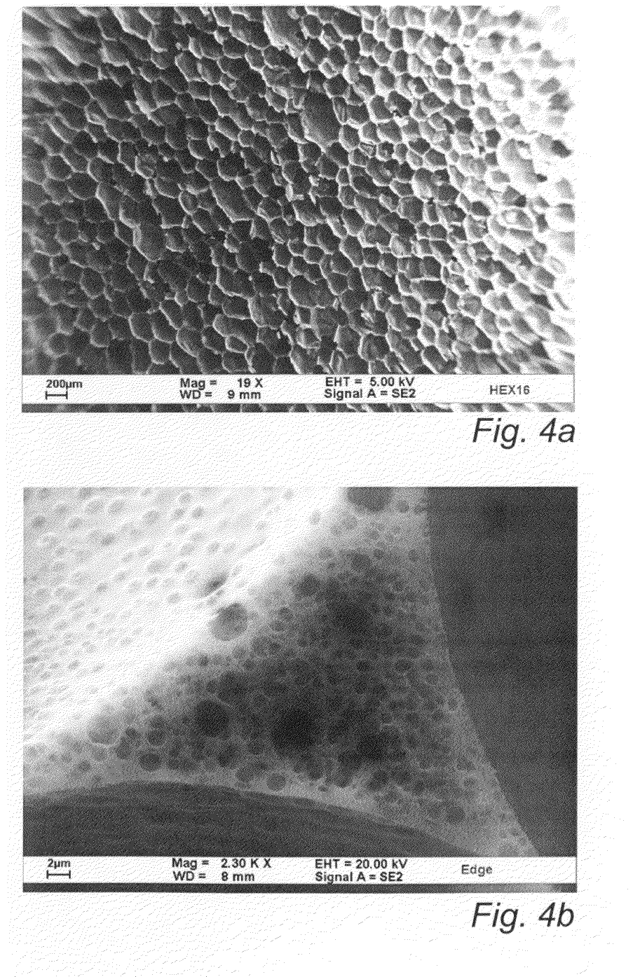

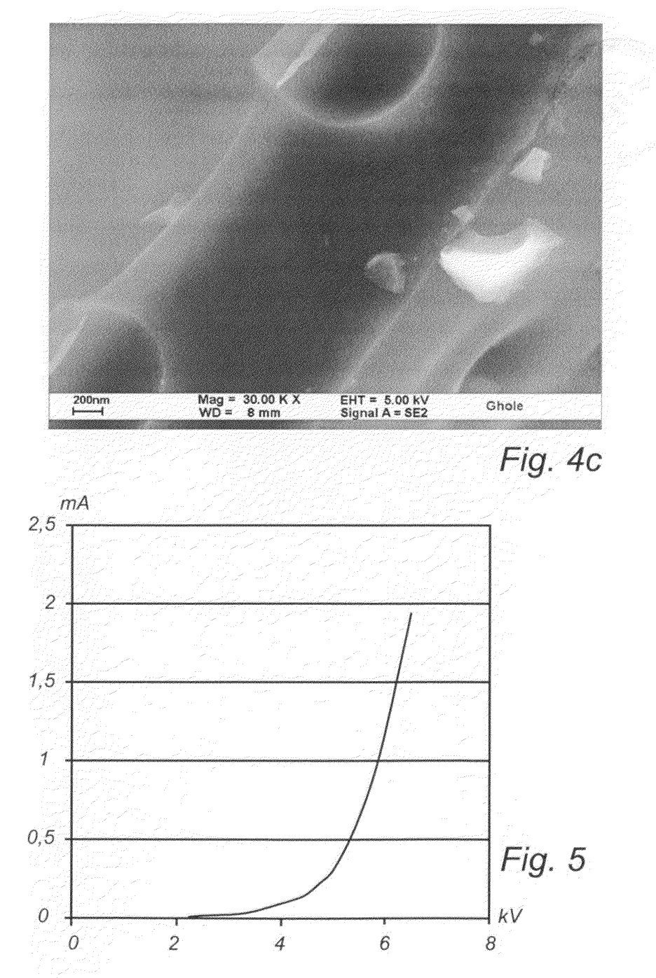

FIGS. 4a to 4c illustrates scanning electron microscope microphotographs of the surface of a carbonized field emission cathode according to the present invention.

FIG. 4a illustrates a continuous cellular structure of two-dimensional interconnected sharp edges, such as knife edges, that can be seen at the surface of the carbonized compound foam material. The compound foam material is transferred from a liquid compound comprising a phenolic resin and at least one of an alkaline metal salt, an alkaline metal oxide.

FIG. 4b illustrates a close-up view of the image shown in FIG. 4a, wherein an emission site (triple junction) can be seen. This emission site has been formed through the mechanical cutting action as described above.

FIG. 4c illustrates a further close-up view of the image shown in FIG. 4a, wherein a detailed view of a sharp field emission edge can be seen. The sharpness of the edges is determined by the thickness of the walls of the cellular structure.

FIG. 5 is a graph illustrating an experimental test performed on a field emission cathode according to the present invention. The graph shows the typical voltage that has been applied between an anode and a field emission cathode in a field emission application device. Prior art field emission cathodes, such as an RVC cathode as described above, produced an unstable emission current upon the initial application of voltage, which was characterized by a series of spikes in the emission current. With a field emission cathode according to the present invention, instability in emission current is almost minimal or non-existing. Furthermore as can be seen in FIG. 5, the operational current that is needed to reach an applicable emission current, is much lower that in prior art field emission cathodes.

Although the present invention and its advantages have been described in detail, is should be understood that various changes, substitutions and alternations can be made herein without departing from the spirit and scope of the invention as defined by the appended claims. For example the invention is not limited to a field emission cathode wherein the conductive cathode support is a rod, but as will be understood by the person skilled in the art, the conductive cathode support can be of any suitable shape, such as a plate, suitable for use in a field emission device application.

1. A method, for manufacturing a field emission cathode, comprising the steps of: providing a liquid compound comprising a liquid phenolic resin and at least one of a metal salt, a metal oxide;
arranging a conductive cathode support such that said conductive cathode support comes in a vicinity of said liquid compound; and
heating said liquid compound, thereby forming a solid compound foam, transformed from said liquid compound, said solid compound foam at least partly covering said conductive cathode support.

2. A method according to claim 1, wherein the method further comprises the step of performing a pyrolysis process on said solid compound foam at least partly covering said conductive cathode support, thereby forming a carbonized solid compound foam.

3. A method according to claim 2, wherein the method further comprises the step of performing a cutting action on said carbonized solid compound foam, thereby forming a carbonized solid compound foam with a plurality of sharp emission edges.

4. A method according to claim 1, wherein the step of arranging a conductive cathode support such that said conductive cathode support comes in a vicinity of said liquid compound, comprises the step of arranging said conductive cathode support and said liquid compound in a container.

5. A method according to claim 4, wherein said conductive cathode support is a rod, wherein said container is a substantially cylindrical container, and wherein the step of heating said liquid compound comprises the step of substantially aligning a longitudinal centre axis of said substantially cylindrical container with a horizontal plane axis.

6. A method according to claim 5, wherein the step of heating said liquid compound in said substantially cylindrical container comprises the step of rotating said substantially cylindrical container around its substantially horizontal axis.

7. A method according to claim 3, wherein said carbonized solid compound foam has a continuous cellular structure.

8. A cathode, for emitting electrons when a potential difference is applied between the cathode and an anode in a field emission device application, comprising a conductive cathode support and a carbonized solid compound foam at least partly covering said conductive cathode support, wherein said carbonized solid compound foam is transformed from a liquid compound comprising a phenolic resin and at least one of a metal salt, a metal oxide.

9. A cathode according to claim 8, wherein said carbonized solid compound foam has a continuous cellular structure.

10. A cathode according to claim 8, wherein said carbonized solid compound foam further comprises a plurality of sharp emission edges arranged at the surface of said carbonized solid compound foam.

11. An apparatus for manufacturing a cathode, for use in a field emission device application, comprising:
means for providing a liquid compound comprising a liquid phenolic resin and at least one of a metal, a metal salt, a metal oxide;
means for arranging a conductive cathode support such that said conductive cathode support comes in a vicinity of said liquid compound; and
means for heating said liquid compound, thereby forming a solid compound foam, transformed from said liquid compound, said solid compound foam at least partly covering said conductive cathode support.

12. A field emission device application comprising
a cathode, comprising a conductive cathode support and a carbonized solid compound foam at least partly covering said conductive cathode support, wherein said carbonized solid compound foam is transformed from a liquid compound comprising a phenolic resin and at least one of a metal salt, a metal oxide;
an anode;
means for arranging said anode and said cathode in an evacuated chamber; and
control electronics.

13. A field emission device application according to claim 12, wherein said field emission device application is one of a lighting source application or an X-ray application.
